(19) United States
(12) Patent Application Publication
(10) Pub. No.: US 2011/0270954 A1
(43) Pub. Date: Nov. 3, 2011

(54) Information Providing Apparatus, Information Providing Method, Program, Information Processing Apparatus, Service Providing Apparatus, and Information Processing System

(76) Inventors: Norifumi KIKKAWA, Tokyo (JP); YASUNORI NAGATOMO, TOKYO (JP); MASAHIRO HARA, TOKYO (JP)

(21) Appl. No.: 13/084,065

(22) Filed: Apr. 11, 2011

(30) Foreign Application Priority Data
Apr. 30, 2010 (JP) P2010-105470

(51) Int. Cl. G06F 15/16

(52) U.S. Cl. 709/219

(57) ABSTRACT

Systems and methods for managing an electronic content list over a network are disclosed. In one embodiment consistent with the disclosure, an information-providing apparatus has a communication unit configured to communicate with an information-processing apparatus over the network and a processing unit. The processing unit is configured receive, via the communication unit, a request from the information-processing apparatus for a list of electronic content items stored at a service-providing unit, to determine, based on information associated with the request, whether the information-processing apparatus supports processing of a list of electronic content items containing at least one null value, and to send, via the communication unit, the list of electronic content items to the information-processing apparatus, only if it is determined that the information-processing apparatus supports processing of a list of electronic content items containing at least one null value.

### PRIORITY APPLICATION

The present application claims the benefit of priority to Japanese Priority Patent Application JP 2010-105470 filed in the Japan Patent Office on Apr. 30, 2010, which is hereby expressly incorporated by reference in its entirety.

### BACKGROUND

1. Technical Field

The present disclosure relates to an information providing apparatus, an information providing method, a program, an information processing apparatus, a service providing apparatus, and an information processing system.

2. Description of the Related Art

Client/server systems are used in various scenes recently. In the client/server system, roles played by computers are shared by a client (which may be hereinafter referred to as “information processing apparatus”) and a server (which may be hereinafter referred to as “information providing apparatus”). In the client/server, a user usually inputs a desired instruction to a client while viewing a screen, and the client transmits a request to a server according to the instruction input by the user. The server receives a request transmitted from the client, executes operation according to the request, and replies a result obtained by executing the operation to the client as a response to the request.

Various kinds of information are transmitted and received between the client and the server. For example, the server transmits, to the client, a content selected by a user from among the contents stored in the server, and the client performs output processing. As indicated in Japanese Patent Application Laid-Open No. 2010-016623, the client usually obtains a content list including a list of data respectively related to contents and allows the user to view the obtained content list, so that the user can select a content.

By the way, the contents and the content list may sometimes be obtained by the server from another apparatus (hereinafter referred to as “service providing apparatus”). In such a case, the content list transmitted from the service providing apparatus may include null data. The reason why the content list includes null data is that, for example, when the content list is displayed on a screen, regions corresponding to the null data are represented as null spaces according to a designer's intention. When the designer freely arranges the null data in the content list, the content list can be presented in various manners, for example.

### SUMMARY

However, there may be a client that fails to normally display the content list including the null data. In such a case, the server is liable to be incapable of transmitting the content list including the null data to the client as they are. To avoid this from happening, a method for removing the null data from the content list and transmitting the content list without the null data to the client may be considered. However, such a method brings about a state in which the server has to bear the load for generating the content list without the null data.

When the service providing apparatus transmits a content list to the server, or the server transmits a content list to the client, it is difficult to transmit data including all the items constituting the content list at one time. In either case, the number of items that can be transmitted is usually limited. In such a case, for example, the number of items of data from which the null data are removed in the server may not reach the number of items of data that can be transmitted to the client. Accordingly, the server needs to repeatedly obtain the content list from the service providing apparatus so as to obtain the number of items of data that can be transmitted to the client. Therefore, there is an issue in that the load is placed on the server.

In view of the foregoing, it is desirable to provide a novel and improved technique capable of flexibly handling a client that fails to normally display a content list including null data and reducing a load placed on a server.

Accordingly, one aspect of the disclosure relates to an information-providing apparatus for managing electronic content on a network. The information-providing apparatus may include a communication unit configured to communicate with an information-processing apparatus over the network and a processing unit. The processing unit may be configured to receive, via the communication unit, a request from the information-processing apparatus for a list of electronic content items stored at a service-providing unit, to determine, based on information associated with the request, whether the information-processing apparatus supports processing of a list of electronic content items containing at least one null value, and to send, via the communication unit, the list of electronic content items to the information-processing apparatus, only if it is determined that the information-processing apparatus supports processing of a list of electronic content items containing at least one null value.

Another aspect relates to a method for managing electronic content on a network. The method may include receiving, from an information-processing apparatus over the network, a request for a list of electronic content items stored at a service-providing unit, determining, based on information associated with the request, whether the information-processing apparatus supports processing of a list of electronic content items containing at least one null value, and sending the list of electronic content items to the information-processing apparatus over the network, only if it is determined that the information-processing apparatus supports processing of a list of electronic content items containing at least one null value.

Another aspect relates to a non-transitory computer-readable storage medium storing instructions which, when executed by an information-providing apparatus, cause the information-providing apparatus to perform a method for managing electronic content on a network. The method may include receiving, from an information-processing apparatus over the network, a request for a list of electronic content items stored at a service-providing unit, determining, based on information associated with the request, whether the information-processing apparatus supports processing of a list of electronic content items containing at least one null value, and sending the list of electronic content items to the information-processing apparatus over the network, only if it is determined that the information-processing apparatus supports processing of a list of electronic content items containing at least one null value.

Another aspect relates to an information-processing apparatus for receiving an electronic content list over a network. The information process-processing apparatus may include a communication unit configured to communicate with an information-providing apparatus over the network, an input unit configured to receive input from a user of the information-processing apparatus, and a processing unit. The processing unit may be configured to receive, via the input unit, input indicative of a request for a list of electronic content items stored at a service-providing unit, to send, via the communication unit, the request to an information-providing apparatus, the request including information indicating whether the information-processing apparatus supports processing of a list of electronic content items containing at least one null value, and to receive, via the communication unit from the information-providing apparatus, the requested list of electronic content items only when the information-processing apparatus supports processing of a list of electronic content items containing at least one null value.

Another aspect relates to a computer-implemented method for receiving an electronic content list over a network. The method may include receiving, at an information-processing apparatus, input indicative of a request for a list of electronic content items stored at a service-providing unit, sending the request to an information-providing apparatus over the network, the request including information indicating whether the information-processing apparatus supports processing of a list of electronic content items containing at least one null value, and receiving, from the information-providing apparatus over the network, the requested list of electronic content items only when the information-processing apparatus supports processing of a list of electronic content items containing at least one null value.

Another aspect relates to a non-transitory computer-readable storage medium storing instructions which, when executed by an information-processing apparatus, cause the information-processing apparatus to perform a method for receiving an electronic content list over a network. The method may include receiving, at the information-processing apparatus, input indicative of a request for a list of electronic content items stored at a service-providing unit, sending the request to an information-providing apparatus over the network, the request including information indicating whether the information-processing apparatus supports processing of a list of electronic content items containing at least one null value, and receiving, from the information-providing apparatus over the network, the requested list of electronic content items only when the information-processing apparatus supports processing of a list of electronic content items containing at least one null value.

Another aspect relates to a service-providing apparatus for providing an electronic content list over a network. The service-providing apparatus may include a communication unit configured to communicate with an information-providing apparatus over the network, a storage unit storing a list of one or more electronic content items, and a processing unit. The processing unit may be configured to receive, via the communication unit from the information-providing apparatus, an indication of a request of an information-processing apparatus for at least a portion of the list of one or more electronic content items, the request indicating that the information-processing apparatus supports processing of a list of electronic content items containing at least one null value, and to send the requested portion of the list of the one or more electronic content items to the information-providing apparatus via the communication unit.

Another aspect relates to a computer-implemented method for providing an electronic content list over a network. The method may include storing, at a service-providing apparatus, a list of one or more electronic content items, receiving, over the network from an information-providing apparatus, an indication of a request of an information-processing apparatus for at least a portion of the list of one or more electronic content items, the request indicating that the information-processing apparatus supports processing of a list of electronic content items containing at least one null value, and sending the requested portion of the list of the one or more electronic content items to the information-providing apparatus via the communication unit.

Finally, another aspect relates to a non-transitory computer-readable storage medium storing instructions which, when executed by a service-providing apparatus, cause the service-providing apparatus to perform a method for providing an electronic content list over a network. The method may include storing, at the service-providing apparatus, a list of one or more electronic content items, receiving, over the network from an information-providing apparatus, an indication of a request of an information-processing apparatus for at least a portion of the list of one or more electronic content items, the request indicating that the information-processing apparatus supports processing of a list of electronic content items containing at least one null value, and sending the requested portion of the list of the one or more electronic content items to the information-providing apparatus via the communication unit.

As described above, according to the present disclosure, it is possible to flexibly handle a client that fails to normally display a content list including null data and reducing a load placed on a server.

### BRIEF DESCRIPTION OF THE DRAWINGS

FIG. 1 is a figure illustrating a configuration of an information processing system according to the present embodiment;

FIG. 2 is a figure illustrating an overview of functions of the information processing system according to the present embodiment;

FIG. 3 is a figure illustrating a functional configuration of an information providing apparatus according to the present embodiment;

FIG. 4 is a figure illustrating a functional configuration of the information providing apparatus according to the present embodiment;

FIG. 5 is a figure illustrating a functional configuration of an information processing apparatus according to the present embodiment; and

FIG. 6 is a flowchart illustrating a flow of processing executed by the information processing system according to the present embodiment.

### DETAILED DESCRIPTION

Hereinafter, embodiments of the present disclosure will be described in detail with reference to the appended drawings. Note that, in this specification and the appended drawings, structural elements that have substantially the same function and structure are denoted with the same reference numerals, and repeated explanation of these structural elements is omitted.

The “Detailed Description” will be explained in the order listed below.

1. Embodiment
1-1. Configuration of information processing system
1-2. Overview of functions of information processing system
1-3. Functional configuration of service providing apparatus
1-4. Functional configuration of information providing apparatus
1-5. Functional configuration of information processing apparatus
1-6. Flow of processings executed by information processing system

2. Modification

3. Conclusion

### 1. EMBODIMENT

### 1-1. Configuration of Information Processing System

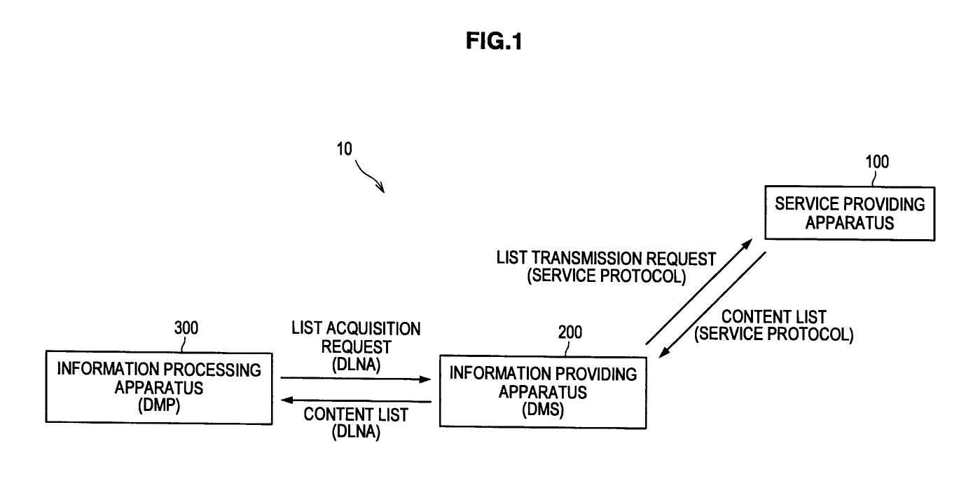

FIG. 1 is a figure illustrating a configuration of an information processing system according to the present embodiment. As shown in FIG. 1, an information processing system 10 includes a service providing apparatus 100, an information providing apparatus 200, and an information processing apparatus 300. For example, the information providing apparatus 200 and the information processing apparatus 300 are in the same home network. For example, the information providing apparatus 200 functions as a DMS (Digital Media Server). For example, the information processing apparatus 300 functions as a DMP (Digital Media Player). In other words, the information processing apparatus 300 obtains contents and a content list from the information providing apparatus 200 according to DLNA (Digital Living Network Alliance).

Examples of content types include music data, video data, and text data. However, the content types are not limited thereto. The content list is not a content itself. The content list is a list of data related to contents. Example of data related to contents include a name of a content, information representing a content, and a name of a person related to a content. However, the data related to contents are not limited thereto.

When the information processing apparatus 300 obtains a content list from the information providing apparatus 200, the information processing apparatus 300 transmits a list acquisition request to the information providing apparatus 200, and receives a content list transmitted from the information providing apparatus 200 as a response to the list transmission request, for example. The information processing apparatus 300 obtains, from the information providing apparatus 200, a content selected by a user from the content list.

The contents and the content list transmitted to the information processing apparatus 300 may be actually stored in the service providing apparatus 100, i.e., an apparatus other than the information providing apparatus 200. In such a case, the information providing apparatus 200 functions as a relay apparatus for relaying the content list stored in the service providing apparatus 100 to the information processing apparatus 300. In other words, in a case where the information providing apparatus 200 and the information processing apparatus 300 are in the same home network, the information providing apparatus 200 functions as a virtual DMS as if actually storing the contents and the content list therein and providing them to the information processing apparatus 300. The information providing apparatus 200 and the service providing apparatus 100 are connected via, for example, the Internet, and can communicate with each other via the Internet.

The content list transmitted from the service providing apparatus 100 may includes null data (hereinafter referred to as “padding object”). The reason why the content list includes null data is that, for example, when the information processing apparatus 300 displays the content list on a screen, regions corresponding to the null data are represented as null spaces according to a designer's intention. When the designer freely arranges the null data in the content list, the content list can be presented in various manners, for example.

However, the information processing apparatus 300 may fail to normally display the content list including the null data. In such a case, the information providing apparatus 200 is incapable of transmitting the content list including the null data to the information processing apparatus 300 as it is. A method for causing the information providing apparatus 200 to remove the null data from the content list and transmitting the content list without the null data to the information processing apparatus 300 may be considered. However, such a method has an issue in that the load for generating the content list without the null data is placed on the information providing apparatus 200.

In this specification, a technique will be described in detail. With this technique, the information processing apparatus 300 that is incapable of normally displaying the content list including the null data can be flexibly handled while reducing the load placed on the information providing apparatus 200.

### 1-2. Overview of Functions of Information Processing System

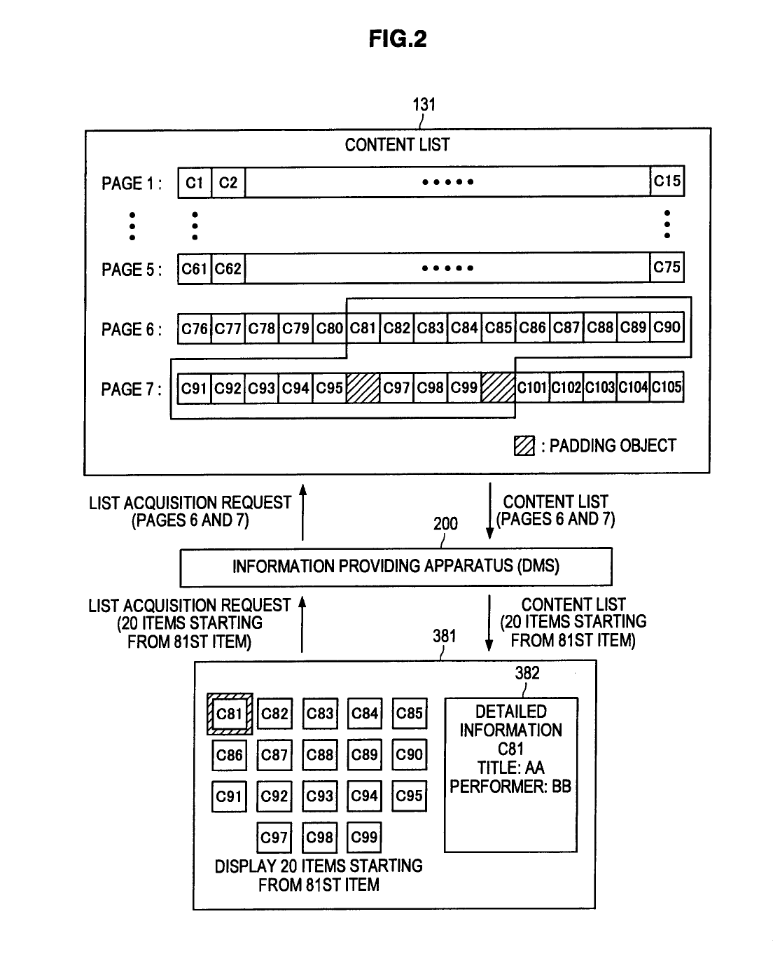

FIG. 2 is a figure illustrating an overview of functions of the information processing system according to the present embodiment. As shown in FIG. 2, in response to operation performed by a user, the information processing apparatus 300 transmits a list acquisition request to the information providing apparatus 200, and the information providing apparatus 200 transmits a list transmission request generated according to the list acquisition request to the service providing apparatus 100. When the service providing apparatus 100 receives the list transmission request, the service providing apparatus 100 transmits a content list 131 to the information processing apparatus 300 via the information providing apparatus 200. The information processing apparatus 300 displays icons of obtained data C81 to C100 (however, data C96, C100 are null spaces) on a display screen 381, and displays data C81 selected by a user within a detailed information window 382.

When the service providing apparatus 100 transmits a content list to the information providing apparatus 200, or when the information providing apparatus 200 transmits a content list to the information processing apparatus 300, it is not necessary to process the data (data C1 to C105) for all the items constituting the content list 131 at one time. In either case, the number of items that can be transmitted is usually limited. FIG. 2 shows a case where the service providing apparatus 100 can transmit data in units of 15 items (1 page) to the information providing apparatus 200 at one time, and the information providing apparatus 200 can process 20 items for the information processing apparatus 300 at one time.

In such a case, for example, the number of items of data from which the null data are removed in the information providing apparatus 200 may not reach the number of items of data that can be transmitted to the client. Accordingly, the information providing apparatus 200 needs to repeatedly obtain the content list 131 from the service providing apparatus 100 so as to obtain the number of items of data that can be transmitted to the information processing apparatus 300. Therefore, there is an issue in that the load is placed on the information providing apparatus 200. According to the present embodiment, the load placed on the information providing apparatus 200 can thus be reduced.

In the description below, for example, various kinds of information included in a request and a response are set by a transmission source at a predetermined position in the request and the response defined for respective types of information, and are obtained by a transmission destination from the predetermined position.

### 1-3. Functional Configuration of Service Providing Apparatus

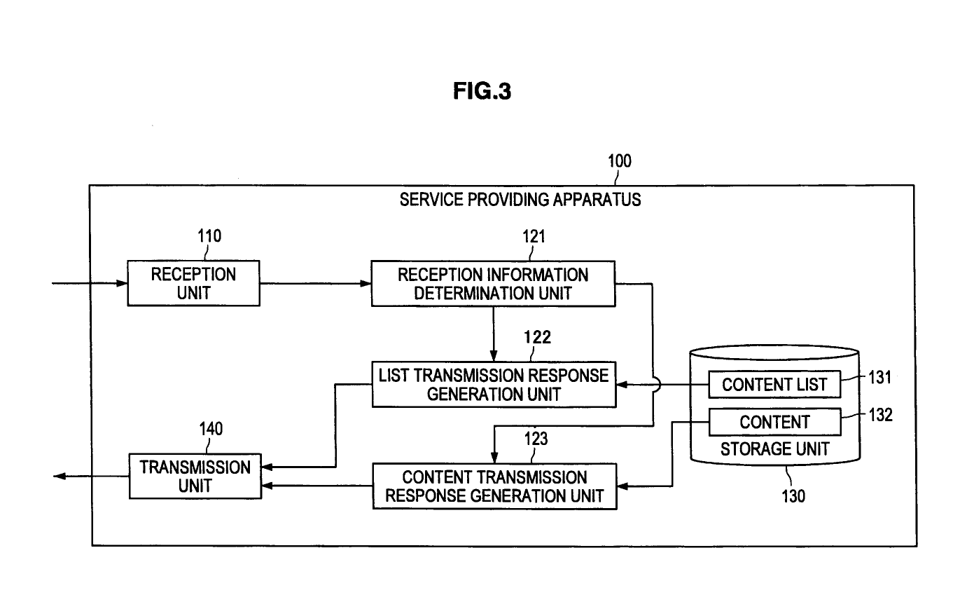

FIG. 3 is a figure illustrating a functional configuration of the service providing apparatus according to the present embodiment. The service providing apparatus 100 includes, at least, a storage unit 130, a reception unit 110, and a transmission unit 140.

The storage unit 130 stores content 132 and a content list 131 including a list of data respectively related to the contents 132. In the example as shown in FIG. 2, the storage unit 130 stores the first to 105th items of content as the content 132, and stores data C1 to C105 respectively related to the first to 105th items of content as the content list 131. The content list 131 includes the above null data (in the example shown in FIG. 2, data C96, C100). For example, the storage unit 130 is constituted by a storage device such as an HDD (Hard Disk Drive) and a semiconductor memory.

The reception unit 110 has a function of receiving the list transmission request, i.e., request for giving an instruction of transmission of the content list 131, from the information providing apparatus 200. The format of the list transmission request is not particularly limited. The reception unit 110 has a function of receiving a content transmission request, i.e., request for giving an instruction of transmission of the content 132, from the information providing apparatus 200. For example, the reception unit 110 is constituted by a communication device, and functions as a communication interface with the information providing apparatus 200.

The transmission unit 140 has a function of transmitting a list transmission response, i.e., response including the content list 131 stored in the storage unit 130, to the information providing apparatus 200, as a response to the transmission request received by the reception unit 110. The transmission unit 140 has a function of, when the content list 131 includes null data, transmitting the list transmission response including the content list 131 including null data, as a response to the list transmission request, to the information providing apparatus 200. The format of the list transmission response is not particularly limited. In addition, the transmission unit 140 has a function of transmitting a content transmission response including the content 132 stored in the storage unit 130, as a response to the content transmission request received by the reception unit 110, to the information providing apparatus 200. For example, the transmission unit 140 is constituted by a communication device, and functions as a communication interface with the information providing apparatus 200.

The service providing apparatus 100 includes a reception information determination unit 121, a list transmission response generation unit 122, a content transmission response generation unit 123, and the like. The reception information determination unit 121 has a function of determining information received by the reception unit 110. For example, when information received by the reception unit 110 includes information for identifying a list transmission request received by the reception unit 110, the reception information determination unit 121 determines that the information received by the reception unit 110 is a list transmission request, and outputs the request to the list transmission response generation unit 122. For example, when information received by the reception unit 110 includes information for identifying a content transmission request received by the reception unit 110, the reception information determination unit 121 determines that the information received by the reception unit 110 is a content transmission request, and outputs the request to the content transmission response generation unit 123.

The list transmission response generation unit 122 has a function of obtaining the content list 131 based on the list transmission request, and generating a list transmission response including the obtained content list 131. For example, when the list transmission request includes page numbers of data which are to be obtained from the content list 131, the list transmission response generation unit 122 obtains data corresponding to the page numbers from the content list 131. In the example as shown in FIG. 2, the list transmission response generation unit 122 determines that the list transmission request includes pages 6, 7 as page numbers, and obtains data C76 to C105 corresponding to pages 6, 7 from the content list 131. The list transmission response generation unit 122 generates a list transmission response including the obtained data.

The content transmission response generation unit 123 has a function of obtaining the content 132 based on the content transmission response, and generating a content transmission response including the obtained content 132. For example, when the content transmission request includes content identification information for identifying a content to be obtained from the content 132, the content transmission response generation unit 123 obtains the content identified by the content identification information from the content 132. The content transmission response generation unit 123 generates a content transmission response including the obtained content.

Each of the reception information determination unit 121, the list transmission response generation unit 122, and the content transmission response generation unit 123 is constituted by, for example, a CPU (Central Processing Unit), a RAM (Random Access Memory), and the like. The functions of the reception information determination unit 121, the list transmission response generation unit 122, and the content transmission response generation unit 123 are achieved by causing the CPU to extract programs stored in the storage unit 130 (or other non-transitory computer-readable storage medium) to a RAM and executes the programs. However, the configuration is not limited thereto. Some of the reception information determination unit 121, the list transmission response generation unit 122, and the content transmission response generation unit 123 may be made with dedicated hardware. The storage unit 130 may further store various kinds of data used when the CPU executes the programs.

### 1-4. Functional Configuration of Information Providing Apparatus

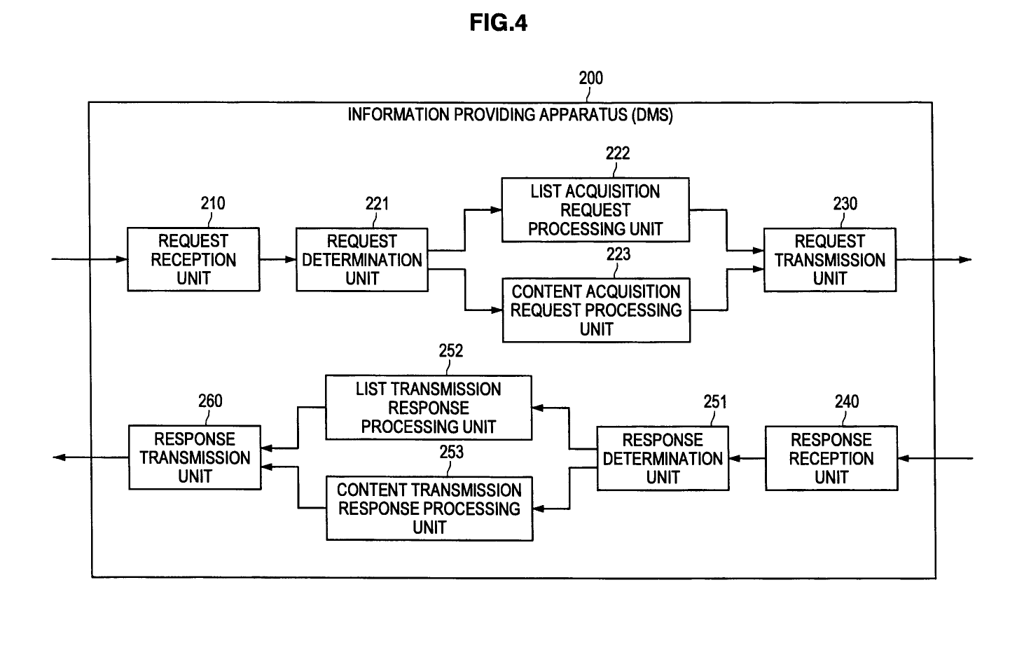

FIG. 4 is a figure illustrating a functional configuration of the information providing apparatus according to the present embodiment. The information providing apparatus 200 includes, at least, a request reception unit 210, a request transmission unit 230, a response reception unit 240, and a response transmission unit 260.

The request reception unit 210 has a function of receiving the list acquisition request for giving an instruction of obtaining the content list 131, i.e., a list of data respectively related to the contents 132, from the information processing apparatus 300. The format of the list acquisition request is not particularly limited. The request reception unit 210 also has a function of receiving the content acquisition request for giving an instruction of obtaining the content list 132 from the information processing apparatus 300. For example, the request reception unit 210 is constituted by a communication device, and functions as a communication interface with the information processing apparatus 300.

The request transmission unit 230 has a function of transmitting a list transmission request for giving an instruction of transmission of the content list 131 to the service providing apparatus 100 providing the content list 131. When the request reception unit 210 receives the list acquisition request, the request transmission unit 230 transmits the list transmission request to the service providing apparatus 100. In addition, the request transmission unit 230 has a function of transmitting a content transmission request for giving an instruction of transmission of the content 132 to the service providing apparatus 100 providing the content 132. When the request reception unit 210 receives the content acquisition request, the request transmission unit 230 transmits the content transmission request to the service providing apparatus 100. For example, the request transmission unit 230 is constituted by a communication device, and functions as a communication interface with the service providing apparatus 100.

The response reception unit 240 has a function of receiving the list transmission response including the content list, as a response to the list transmission request, from the service providing apparatus 100. In addition, the response reception unit 240 has a function of receiving the content transmission response including the content from the service providing apparatus 100 as a response to the content transmission request. For example, the response reception unit 240 is constituted by a communication device, and functions as a communication interface with the service providing apparatus 100.

The response transmission unit 260 has a function of, when the content list included in the list transmission response received by the response reception unit 240 includes null data, transmitting a list acquisition response including a content list including null data to the information processing apparatus 300 as a response to the list acquisition request received by the request reception unit 210. In addition, the response transmission unit 260 has a function of transmitting a content acquisition response including the content, as a response to the content acquisition request received by the request reception unit 210, to the information processing apparatus 300. For example, the response transmission unit 260 is constituted by a communication device, and functions as a communication interface with the information processing apparatus 300.

The information providing apparatus 200 may further include a list acquisition request processing unit 222. The list acquisition request processing unit 222 has a function of determining whether the information processing apparatus 300 can normally perform processing for a case where the information processing apparatus 300 receives a content list including null data. This is to prevent a content list including null data from being transmitted to the information processing apparatus 300 that is incapable of normally processing the content list including null data. In this case, when the list acquisition request processing unit 222 determines that the information processing apparatus 300 can normally perform processing for a case where the information processing apparatus 300 receives a content list including null data, the request transmission unit 230 transmits the list transmission request to the service providing apparatus 100.

On the other hand, when the list acquisition request processing unit 222 determines that the information processing apparatus 300 can normally perform processing for a case where the information processing apparatus 300 receives a content list including null data, the following processing is performed. That is, the request transmission unit 230 omits transmission of the list transmission request to the service providing apparatus 100, the response transmission unit 260 transmits, to the information processing apparatus 300, a list acquisition response indicating that there is no data respectively related to the contents, instead of the response including the content list including null data.

Various kinds of methods are considered as a method for determining whether the information processing apparatus 300 can normally perform processing for a case where the information processing apparatus 300 receives a content list including null data. For example, the list acquisition request processing unit 222 determines, based on the type of the information processing apparatus 300 included in the list acquisition request received by the request reception unit 210, whether the information processing apparatus 300 can normally perform processing for a case where the information processing apparatus 300 receives a content list including null data.

The type of the information processing apparatus 300 may be included in the list acquisition request by the information processing apparatus 300, for example. For example, when the information providing apparatus 200 provides a CDS (Content Directory Service), and the information processing apparatus 300 uses Browse command as a list acquisition request, a filter argument of Browse command can be used as the type of the information processing apparatus 300. When Search command is used as the list acquisition request, the information processing apparatus 300 can also use a filter argument as the type of the information processing apparatus 300 in the same manner as the case where Browse command is used. In the description below, Browse command is mainly used as a list acquisition request, for example.

The filter argument is an argument used to limit a content list to be obtained from the content list that can be provided by the service providing apparatus 100. For example, the information processing apparatus 300 capable of using a service provided by the service providing apparatus 100 may use a method in which a filter argument of Browse command needs setting of information for identifying the type of the service provided by the service providing apparatus 100. This is because which of a content list including null data and a content list not including null data is provided by the service providing apparatus 100 is considered to be determined according to the type of the service provided by the service providing apparatus 100.

An example of a type of a service for providing a content to a television set via the Internet by the server includes BIVL (Bravia Internet Video Link). BIVL is an example of service for providing a content list including null data to the information processing apparatus 300 by the service providing apparatus 100. In a case where the service providing apparatus 100 corresponds to the server, and the information processing apparatus 300 corresponds to a television set for using BIVL service provided by the server, the information processing apparatus 300 may use a method in which a value indicating availability of BIVL is set to a filter argument of Browse command. The value indicating availability of BIVL may use, for example “av:BIVL” and the like.

There may be a possibility that a value not recognized by the information providing apparatus 200 is set to the filter argument. Even in such a case, the information providing apparatus 200 may disregard the value not recognized by the information providing apparatus 200, for example. As described above, the method for using the filter argument of the command as the type of the information processing apparatus 300 can be employed only by applying improvement in the level of application. Therefore, there is an advantage in that the method can be easily improved.

As shown in FIG. 2, the information providing apparatus 200 is considered to transmit the content list to the information processing apparatus 300 in units of a predetermined number of items, and the service providing apparatus 100 is considered to transmit the content list to the information providing apparatus 200 in units of pages. In this case, the list acquisition request is considered to include information representing a range of data to be obtained in the content list, i.e., a number X representing a head of data to be obtained and the number of items of data Y to be obtained, and the list transmission response includes data in units of pages in which the data are divided into pieces each having a predetermined number of items N.

In this case, the information providing apparatus 200 includes, for example, a list transmission response processing unit 252. The list acquisition request processing unit 222 divides X by N to obtain a quotient Q1 (where Q1 is an integer equal to or more than zero) and a remainder R1 (where R1 is an integer equal to or more than zero), and divides (X+Y) by N to obtain a quotient Q2 (where Q2 is an integer equal to or more than zero) and a remainder R2 (where R2 is an integer equal to or more than zero). The list acquisition request processing unit 222 adopts Q1 as P1 where R1 is equal to zero, and adopts Q1+1 as P1 where R1 is not equal to zero. The list acquisition request processing unit 222 adopts Q2 as P2 where R2 is equal to zero, and adopts Q2+1 as P2 where R2 is not equal to zero. The list acquisition request processing unit 222 makes the list transmission request including integers from P1 to P2. The response reception unit 240 receives a list transmission response including pages from page P1 to page P2 as a response to the list transmission request.

The list transmission response processing unit 252 may extract data between (R1+1)th item of data with respect to the beginning of page P1 and (R2)th item of data with respect to the beginning of page P2 from among the pages between page P1 and page P2 included in the list transmission response received by the response reception unit 240, and may include the extracted data in the list response. (R1+1) means a value obtained by adding the remainder R1 and one.

The information providing apparatus 200 may further include a content acquisition request processing unit 223. The content acquisition request processing unit 223 generates a request including content identification information included in the content acquisition request as a content transmission request, and outputs the content transmission request to the request transmission unit 230.

The information providing apparatus 200 may include a request determination unit 221. The request determination unit 221 has a function of determining a request received by the request reception unit 210. For example, when a request received by the request reception unit 210 includes information for identifying a list acquisition request, the request determination unit 221 determines that the request received by the request reception unit 210 is the list acquisition request, and outputs the request to the list acquisition request processing unit 222. For example, when a request received by the request reception unit 210 includes information for identifying a content acquisition request, the request determination unit 221 determines that the request received by the request reception unit 210 is the content acquisition request, and outputs the request to the content acquisition request processing unit 223.

The information providing apparatus 200 may further include a list transmission response processing unit 252. The list transmission response processing unit 252 generates a response including a content list included in the list transmission response as a list acquisition response, and outputs the list acquisition response to the response transmission unit 260.

The information providing apparatus 200 may further include a content transmission response processing unit 253. The content transmission response processing unit 253 generates a response including a content included in the content transmission response as a content acquisition response, and outputs the content acquisition response to the response transmission unit 260.

The information providing apparatus 200 may further include a response determination unit 251. The response determination unit 251 has a function of determining a response received by the response reception unit 240. For example, when a response received by the response reception unit 240 includes information for identifying a list transmission response, the response determination unit 251 determines that the response received by the response reception unit 240 is the list transmission response, and outputs the response to the list transmission response processing unit 252. For example, when a response received by the response reception unit 240 includes information for identifying a content transmission response, the response determination unit 251 determines that the response received by the response reception unit 240 is the content transmission response, and outputs the response to the content transmission response processing unit 253.

Each of the request determination unit 221, the list acquisition request processing unit 222, the content acquisition request processing unit 223, the response determination unit 251, the list transmission response processing unit 252, and the content transmission response processing unit 253 is constituted by, for example, a CPU, a RAM, and the like. The functions of the request determination unit 221, the list acquisition request processing unit 222, the content acquisition request processing unit 223, the response determination unit 251, the list transmission response processing unit 252, and the content transmission response processing unit 253 are achieved by causing the CPU to extract programs stored in a storage unit (or other non-transitory computer-readable storage medium), not shown, to a RAM and executes the programs. However, the configuration is not limited thereto. Some of the request determination unit 221, the list acquisition request processing unit 222, the content acquisition request processing unit 223, the response determination unit 251, the list transmission response processing unit 252, and the content transmission response processing unit 253 may be made with dedicated hardware. The storage unit, not shown, may further store various kinds of data used when the CPU executes the programs.

### 1-5. Functional Configuration of Information Processing Apparatus

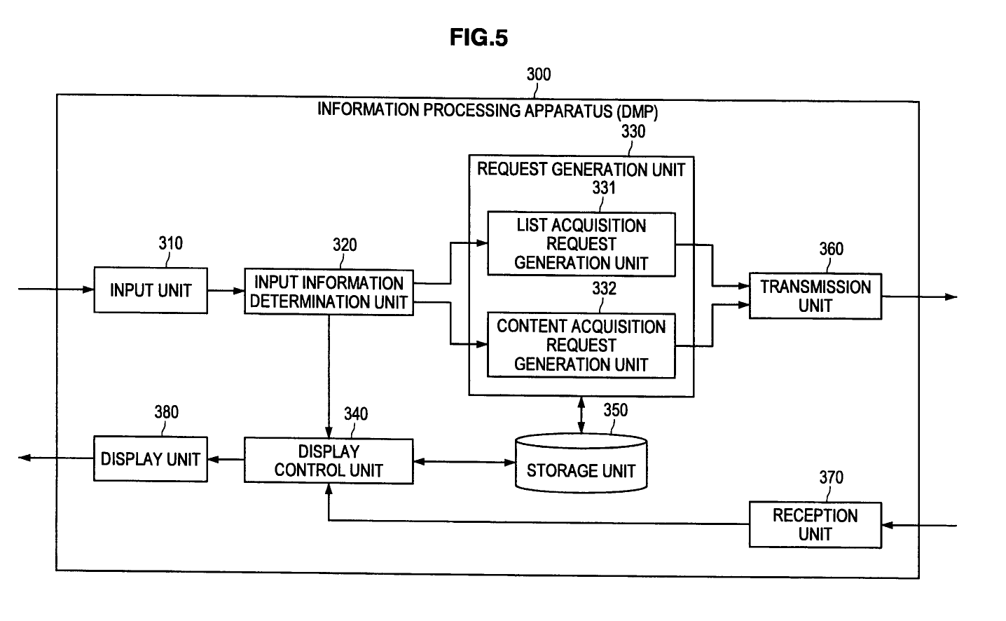

FIG. 5 is a figure illustrating a functional configuration of an information processing apparatus according to the present embodiment. The information processing apparatus 300 includes, at least, the transmission unit 360 and the reception unit 370. FIG. 5 shows the information processing apparatus 300 capable of normally performing processing for a case where the information processing apparatus 300 receives a content list including null data.

The transmission unit 360 has a function of transmitting, to the information providing apparatus 200, a list acquisition request for giving an instruction of obtaining a content list including a list of data respectively related to contents. In addition, the transmission unit 360 has a function of transmitting a content acquisition request for giving an instruction of obtaining the content to the information providing apparatus 200. For example, the transmission unit 360 is constituted by a communication device, and functions as a communication interface with the information providing apparatus 200.

The reception unit 370 has a function of receiving a list acquisition response including a content list including null data, as a response to the list acquisition request transmitted by the transmission unit 360, from the information providing apparatus 200. In addition, the reception unit 370 has a function of receiving the content acquisition response including the content, as a response to the content acquisition request transmitted by the transmission unit 360, from the information providing apparatus 200. For example, the reception unit 370 is constituted by a communication device, and functions as a communication interface with the information providing apparatus 200.

The information processing apparatus 300 may further include a display control unit 340. The display control unit 340 has a function of causing a display unit 380 to display the content list included in the list acquisition response received by the reception unit 370 from the information providing apparatus 200. As described above, the information processing apparatus 300 can normally perform processing for a case where the information processing apparatus 300 receives a content list including null data. In this case, when the content list includes null data, the display control unit 340 causes the display unit 380 to display the content list in such a manner that spaces are arranged in display regions corresponding to the null data. In the example as shown in FIG. 2, the display control unit 340 causes the display unit 380 to display the content list in such a manner that spaces are arranged in display regions corresponding to the null data C96, C100. For example, the display control unit 340 causes the display unit 380 to display the content list on the display screen 381.

The display control unit 340 has a function of displaying, in the detailed information window 382, data selected by the input information determination unit 320 from the content list included in the list acquisition response. Further, the display control unit 340 may display a cursor at a position where the selected data are displayed. In the example as shown in FIG. 2, the input information determination unit 320 selects data C81. In this example, the display unit 380 is considered to reside in the information processing apparatus 300. Alternatively, the display unit 380 may reside outside of the information processing apparatus 300. The display unit 380 has a function of displaying a content list according to the control of the display control unit 340. The display unit 380 is constituted by, for example, a display device.

The information processing apparatus 300 may further include a list acquisition request generation unit 331. The list acquisition request generation unit 331 has a function of generating a list acquisition request. For example, the list acquisition request generation unit 331 may make the list acquisition request including range information representing a range of data in the content list which are to be obtained. For example, the range information specifies a number X representing a head of data to be obtained and the number of items of data Y to be obtained. For example, the number X representing a head of data to be obtained and the number of items of data Y to be obtained are selected by the input information determination unit 320 based on the information input by a user via an input unit 310. For example, the number of items of data Y to be obtained may be determined according to a protocol between the information processing apparatus 300 and the information providing apparatus 200.

The information processing apparatus 300 may further include the content acquisition request generation unit 332. The content acquisition request generation unit 332 has a function of generating the content acquisition request. For example, the content acquisition request generation unit 332 may make the content acquisition request including the content identification information for identifying a content to be obtained. For example, the content identification information included in the content acquisition request at this moment is included in the data selected from the content list by the input information determination unit 320 based on information input by the user via the input unit 310.

The information processing apparatus 300 may further include an input unit 310 and an input information determination unit 320. The input unit 310 receives information input by the user. For example, the input unit 310 is constituted by an input device such as a keyboard and a mouse.

The input information determination unit 320 has a function of selecting one or a plurality of pieces of data, based on information input by the user via the input unit 310, from the content list included in the list acquisition response. The input information determination unit 320 outputs the content identification information included in the selected data to the content acquisition request generation unit 332 and the display control unit 340. The input information determination unit 320 has a function of selecting the number X representing a head of data to be obtained and the number of items of data Y to be obtained from the content list provided by the service providing apparatus 100 based on information input by the user via the input unit 310. The input information determination unit 320 outputs the selected number X and the selected number of items Y to the list acquisition request generation unit 331.

For example, the storage unit 350 is constituted by a storage device such as an HDD and a semiconductor memory.

Each of a request generation unit 330 including the list acquisition request generation unit 331 and the content acquisition request generation unit 332, and each of the input information determination unit 320 and the display control unit 340 is constituted by, for example, a CPU, a RAM, and the like. The functions of the request generation unit 330 including the list acquisition request generation unit 331 and the content acquisition request generation unit 332, and the input information determination unit 320 and the display control unit 340 are achieved by causing the CPU to extract programs stored in the storage unit 350 (or other non-transitory computer-readable storage medium) to a RAM and executes the programs. However, the configuration is not limited thereto. Some of the request generation unit 330, the input information determination unit 320, and the display control unit 340 may be made with dedicated hardware. The storage unit 350 may further store various kinds of data used when the CPU executes the programs.

### 1-6. Flow of Processing Executed by Information Processing System

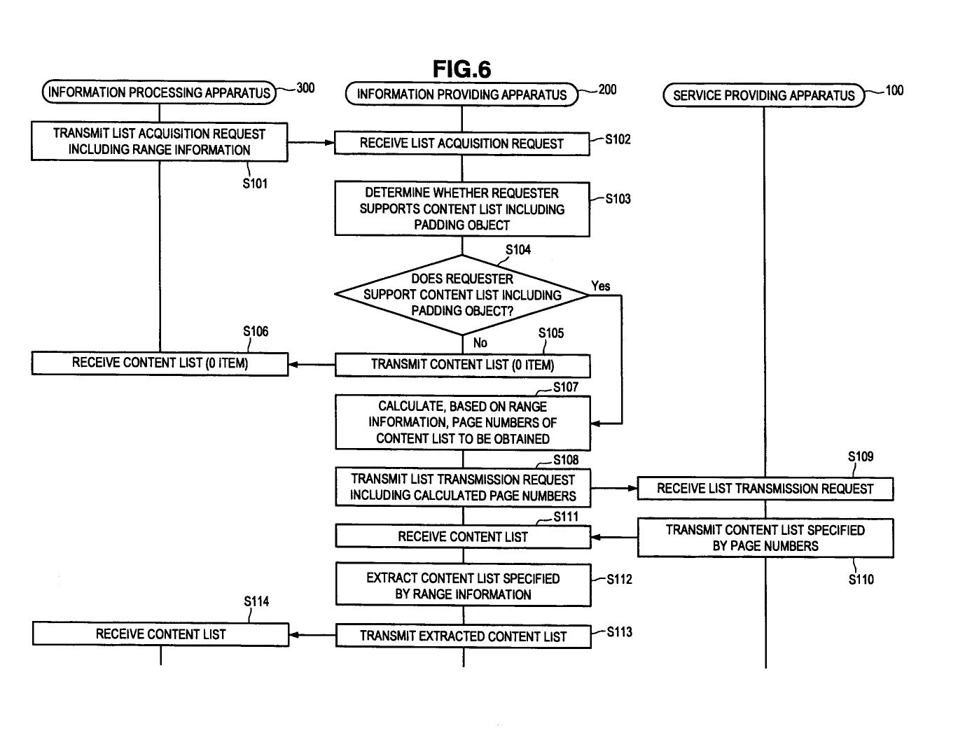

FIG. 6 is a flowchart illustrating a flow of processing executed by the information processing system according to the present embodiment. The flowchart as shown in FIG. 6 shows an example of processing executed by the information processing system 10. However, the processing executed by the information processing system 10 is not limited to the processing as shown in this flowchart.

First, the information processing apparatus 300 transmits, to the information providing apparatus 200, a list acquisition request including range information representing a range of data to be obtained from the content list (step S101). The information providing apparatus 200 receives a list acquisition request from the information processing apparatus 300 (step S102), and the information providing apparatus 200 determines whether a requester (the information processing apparatus 300 transmitted the list acquisition request) supports a content list including a padding object (null data) (step S103).

When the information providing apparatus 200 determines that the requestor does not support a content list including the padding object (“No” in step S104), the information providing apparatus 200 transmits a content list (0 item) to the information processing apparatus 300 (step S105). Then, the information processing apparatus 300 receives the content list (0 item) transmitted from the information providing apparatus 200 (step S106). The content list (0 item) means that there is no content list.

When the information providing apparatus 200 determines that the requester supports the content list including the padding object (“Yes” in step S104), the information providing apparatus 200 calculates page numbers of the content list to be obtained, based on the range information (step S107). When the information providing apparatus 200 transmits a list transmission request including the calculated page numbers to the service providing apparatus 100 (step S108), the service providing apparatus 100 receives the list transmission request transmitted from the information providing apparatus 200 (step S109).

The service providing apparatus 100 obtains the content list specified by the page numbers included in the list transmission request, and transmits the content list to the information providing apparatus 200 (step S110). The information providing apparatus 200 receives the content list transmitted from the service providing apparatus 100 (step S111), and extracts the content list specified by the range information from the received content list (step S112). When the information providing apparatus 200 transmits the extracted content list to the information processing apparatus 300 (step S113), the information processing apparatus 300 receives the content list from the information providing apparatus 200 (step S114).

The information processing apparatus 300 uses the content list received from the information providing apparatus 200 to select contents, and the information processing apparatus 300 can perform processing, e.g., obtaining the selected contents from the service providing apparatus 100.

### 2. MODIFICATION

It should be understood by those skilled in the art that various modifications, combinations, sub-combinations and alterations may occur depending on design requirements and other factors insofar as they are within the scope of the appended claims or the equivalents thereof.

### 3. CONCLUSION

According to the present embodiment, it is not necessary to generate a content list from which null data are removed. Therefore, the load placed on the information providing apparatus 200 can be reduced. In addition, the information processing apparatus 300 that is incapable of normally displaying the content list including the null data can be flexibly handled.

In addition, this prevents a case where the number of items of data from which the null data are removed in the information providing apparatus 200 does not reach the number of items of data that can be transmitted to the information processing apparatus 300. Therefore, the load placed on the information providing apparatus 200 can be further reduced.

What is claimed is:

1. An information-providing apparatus for managing electronic content on a network, the information-providing apparatus comprising:
a communication unit configured to communicate with an information-processing apparatus over the network; and
a processing unit configured to:
receive, via the communication unit, a request from the information-processing apparatus for a list of electronic content items stored at a service-providing unit;
determine, based on information associated with the request, whether the information-processing apparatus supports processing of a list of electronic content items containing at least one null value; and
send, via the communication unit, the list of electronic content items to the information-processing apparatus, only if it is determined that the information-processing apparatus supports processing of a list of electronic content items containing at least one null value.

2. The information-providing apparatus of claim 1, wherein the information-providing apparatus comprises a Digital Media Server (DMS) in a Digital Living Network Alliance (DLNA) environment.

3. The information-providing apparatus of claim 1, wherein the information-processing apparatus comprises a Digital Media Player (DMP) in a Digital Living Network Alliance (DLNA) environment.

4. The information-providing apparatus of claim 1, wherein the at least one null value comprises a padding object between electronic content items in the list.

5. The information-providing apparatus of claim 1, wherein the request comprises a browse command.

6. The information-providing apparatus of claim 1, wherein:
the information associated with the request indicates a type of the information-processing apparatus; and
the processing unit is configured to determine whether the information-processing apparatus supports processing of the list of electronic content items containing at least one null value, based on the indicated type of the information-processing apparatus.

7. The information-providing apparatus of claim 1, wherein:
the information associated with the request includes a filter argument for filtering the list of electronic content items; and
the processing unit is configured to determine whether the information-processing apparatus supports processing of the list of electronic content items containing at least one null value, based on the filter argument.

8. The information-providing apparatus of claim 1, wherein:
the request comprises a command to browse the electronic content items using a Content Director Service (CDS) provided by the information-providing apparatus;
the information associated with the request includes a filter argument for the CDS; and
the processing unit is configured to determine whether the information-processing apparatus supports processing of the list of electronic content items containing at least one null value, based on the filter argument.

9. The information-providing apparatus of claim 1, wherein the processing unit is further configured to transmit no list of electronic content items to the information-processing apparatus when it is determined that the information-processing apparatus does not support processing of a list of electronic content items containing at least one null value.

10. A method for managing electronic content on a network, the method comprising:
receiving, from an information-processing apparatus over the network, a request for a list of electronic content items stored at a service-providing unit;
determining, based on information associated with the request, whether the information-processing apparatus supports processing of a list of electronic content items containing at least one null value; and
sending the list of electronic content items to the information-processing apparatus over the network, only if it is determined that the information-processing apparatus supports processing of a list of electronic content items containing at least one null value.

11. A non-transitory computer-readable storage medium storing instructions which, when executed by an information-providing apparatus, cause the information-providing apparatus to perform a method for managing electronic content on a network, the method comprising:
receiving, from an information-processing apparatus over the network, a request for a list of electronic content items stored at a service-providing unit;
determining, based on information associated with the request, whether the information-processing apparatus supports processing of a list of electronic content items containing at least one null value; and
sending the list of electronic content items to the information-processing apparatus over the network, only if it is determined that the information-processing apparatus supports processing of a list of electronic content items containing at least one null value.

12. An information-processing apparatus for receiving an electronic content list over a network, the information-processing apparatus comprising:
a communication unit configured to communicate with an information-providing apparatus over the network;
an input unit configured to receive input from a user of the information-processing apparatus; and
a processing unit configured to:
receive, via the input unit, input indicative of a request for a list of electronic content items stored at a service-providing unit;
send, via the communication unit, the request to an information-providing apparatus, the request including information indicating whether the information-processing apparatus supports processing of a list of electronic content items containing at least one null value; and
receive, via the communication unit from the information-providing apparatus, the requested list of electronic content items only when the information-processing apparatus supports processing of a list of electronic content items containing at least one null value.

13. A computer-implemented method for receiving an electronic content list over a network, the method comprising:
receiving, at an information-processing apparatus, input indicative of a request for a list of electronic content items stored at a service-providing unit;
sending the request to an information-providing apparatus over the network, the request including information indicating whether the information-processing apparatus supports processing of a list of electronic content items containing at least one null value; and
receiving, from the information-providing apparatus over the network, the requested list of electronic content items only when the information-processing apparatus supports processing of a list of electronic content items containing at least one null value.

14. A non-transitory computer-readable storage medium storing instructions which, when executed by an information-processing apparatus, cause the information-processing apparatus to perform a method for receiving an electronic content list over a network, the method comprising:
receiving, at the information-processing apparatus, input indicative of a request for a list of electronic content items stored at a service-providing unit;
sending the request to an information-providing apparatus over the network, the request including information indicating whether the information-processing apparatus supports processing of a list of electronic content items containing at least one null value; and
receiving, from the information-providing apparatus over the network, the requested list of electronic content items only when the information-processing apparatus supports processing of a list of electronic content items containing at least one null value.

15. A service-providing apparatus for providing an electronic content list over a network, the service-providing apparatus comprising:
a communication unit configured to communicate with an information-providing apparatus over the network;
a storage unit storing a list of one or more electronic content items; and
a processing unit configured to:
receive, via the communication unit from the information-providing apparatus, an indication of a request of an information-processing apparatus for at least a portion of the list of one or more electronic content items, the request indicating that the information-processing apparatus supports processing of a list of electronic content items containing at least one null value; and
send the requested portion of the list of the one or more electronic content items to the information-providing apparatus via the communication unit.

16. A computer-implemented method for providing an electronic content list over a network, the method comprising:
storing, at a service-providing apparatus, a list of one or more electronic content items;
receiving, over the network from an information-providing apparatus, an indication of a request of an information-processing apparatus for at least a portion of the list of one or more electronic content items, the request indicating that the information-processing apparatus supports processing of a list of electronic content items containing at least one null value; and
sending the requested portion of the list of the one or more electronic content items to the information-providing apparatus via the communication unit.

17. A non-transitory computer-readable storage medium storing instructions which, when executed by a service-providing apparatus, cause the service-providing apparatus to perform a method for providing an electronic content list over a network, the method comprising:
storing, at the service-providing apparatus, a list of one or more electronic content items;
receiving, over the network from an information-providing apparatus, an indication of a request of an information-processing apparatus for at least a portion of the list of one or more electronic content items, the request indicating that the information-processing apparatus supports processing of a list of electronic content items containing at least one null value; and
sending the requested portion of the list of the one or more electronic content items to the information-providing apparatus via the communication unit.
